(19) United States
(12) Patent Application Publication
(10) Pub. No.: US 2012/0157540 A1
(43) Pub. Date: Jun. 21, 2012

(54) Disinfectant and Sanitizer Formulations

(76) Inventors: Paula Louise McGeechan, Ramsbottom (GB); William Woods, Paramus, NJ (US)

(21) Appl. No.: 13/351,538

(22) Filed: Jan. 17, 2012

Related U.S. Application Data
(63) Continuation-in-part of application No. 12/727,405, filed on Mar. 19, 2010.
(60) Provisional application No. 61/162,362, filed on Mar. 23, 2009.

(51) Int. Cl. A01N 37/52; A01P 1/00

(52) U.S. Cl. 514/635

(57) ABSTRACT

The present invention relates to disinfectant formulations containing: (i) an antimicrobial active agent selected from the group consisting of biguanides, monoguanides, and combinations thereof; (ii) a compound selected from the group consisting of a dialkyldimethyl ammonium salt, an alkyldimethylbenzyl ammonium salt, an alkyldimethyl(ethylbenzyl) ammonium salt, and combinations thereof wherein the formulation is free of sequestrants. The total amount of the component (i) and the component (ii) is from about 500 ppm to about 1000 ppm based on the weight of the disinfectant formulation, and the component (i) and the component (ii) are present in a range of weight ratios between about 1:1 and about 1:10.

### CROSS REFERENCE TO RELATED APPLICATIONS

This application is a Continuation-In-Part application of U.S. Ser. No. 12/727,405 filed Mar. 19, 2010, which claims the benefit of U.S. Provisional Application Ser. No. 61/162,362 filed Mar. 23, 2009. The disclosures of the application Ser. Nos. 12/727,405 and 61/162,362 are incorporated herein by reference in their entireties.

### BACKGROUND OF THE INVENTION

Quaternary ammonium compounds, such as alkyldimethylbenzyl ammonium chloride (ADBAC) and didecyldimethyl ammonium chloride (DDAC), are known to be effective antimicrobials for use in household and Industrial & Institutional (I&I) sanitizer formulations. Illustratively, U.S. Pat. No. 5,000,867 discloses a sanitizing composition for use in the cleaning-in-place of food industry equipment containing 0.01-5% of quaternary ammonium antimicrobial agents and 0.01-25% of guanidine anti-microbial agents, together with one or more organic acids and one or more inorganic acids.

U.S. Pat. No. 5,529,713 discloses a cleaning and disinfecting composition for household use containing ethoxylated fatty alcohol, co-surfactant, isopropyl alcohol, polyhexamethylene biguanide hydrochloride, didecyl dimethylammonium chloride and benzalkonium chloride. The biocide is present in an amount of from 1 to 40%.

U.S. Patent Application No. 20030100465 discloses a cleaning composition adapted to clean hard surfaces containing a cationic biocide, surfactant and a polymer, where the cationic biocide includes quaternary ammonium compound, biguanide compound, and mixtures thereof.

While quaternary ammonium compounds have proven useful in a wide range of applications, their use in household, industrial and institutional indirect food contact applications is limited due to the regulatory restriction on the maximum permitted use levels of these compounds. For example, EPA 40 CFR 180.940 lists the upper limit for ADBAC at 200 ppm active ingredient and DDAC at 240 ppm active ingredient. At such low levels, these quaternary ammonium compounds are normally not effective for its intended purposes. In addition, these quaternary ammonium compounds are also limited in use flexibility. Accordingly, alternative sanitizer formulations are needed for household indirect food contact applications that are effective, flexible and cost-effective.

Further, the use of quaternary ammonium compounds in hard surface disinfectant applications is also limited due to their relatively low efficacy against Pseudomonas aeruginosa. Accordingly, alternative disinfectant formulations are needed.

### SUMMARY OF THE INVENTION

In one aspect, the present invention relates to a sanitizer formulation comprising: (a) an antimicrobial active agent selected from the group consisting of biguanides, monoguanides, and combinations thereof; (b) a dialkyldimethyl ammonium salt, and (c) a compound selected from the group consisting of an alkyldimethylbenzyl ammonium salt, an alkyldimethyl(ethylbenzyl) ammonium salt, an alkoxylated alcohol, and combinations thereof. The preferred component (a) is polyhexamethylene biguanide or the salts thereof.

In the formulation, the component (a) is present in an amount of from about 25 to about 110 ppm (preferably from about 35 ppm to about 75 ppm), and the component (b) is present in an amount of from about 20 to about 125 ppm (preferably from about 50 ppm to about 100 ppm). In addition, the component (a) and the component (b) are present in a weight ratio range of between about 1:5 to about 2.5 to 1 (preferably between about 1:2 to about 1:1). If present, the alkoxylated alcohol is present in an amount of from about 35 ppm to about 200 ppm (preferably from about 105 ppm to about 125 ppm) and the alkyldimethylbenzyl ammonium salt is present in an amount of from about 20 ppm to about 65 ppm (preferably from about 50 ppm to about 60 ppm).

In another aspect, the present invention also relates to a disinfectant formulation comprising: (i) an antimicrobial active agent selected from the group consisting of biguanides, monoguanides, and combinations thereof; (ii) a compound selected from the group consisting of a dialkyldimethyl ammonium salt, an alkyldimethylbenzyl ammonium salt, an alkyldimethyl(ethylbenzyl) ammonium salt, and combinations thereof, wherein the total amount of the component (i) and the component (ii) is from about 500 ppm to about 1000 ppm based on the weight of the disinfectant formulation, wherein the component (i) and the component (ii) are present in a range of weight ratios between about 1:1 and about 1:10, and wherein the formulation is free of sequestrants.

In yet another aspect, the present invention relates to a disinfectant formulation concentrate that, upon dilution with water, provides a ready to use disinfectant formulation as specified in the above embodiment. The concentrate comprises from about 1% to about 11% of component (a), from about 5% to about 21% of component (b). In the concentrate, the component (a) and the component (b) are present in a weight ratio of from about 1:1 to 1:10, advantageously from about 1:1 to about 1:5, more advantageously from about 1:2 to about 1:5 and wherein the concentrate is free of sequestrants.

In still another aspect, the present invention relates to a method for disinfecting surfaces. The method comprises the step of contacting the ready to use disinfectant formulation with the surface to be disinfected.

These and other aspects will become apparent upon reading the following detailed description of the invention.

### DETAILED DESCRIPTION OF THE INVENTION

It has now been surprisingly found in accordance with the present invention that a disinfectant formulation containing: (i) an antimicrobial active agent selected from the group consisting of biguanides, monoguanides, and combinations thereof; and (ii) a compound selected from the group consisting of a dialkyldimethyl ammonium salt, an alkyldimethylbenzyl ammonium salt, an alkyldimethyl(ethylbenzyl) ammonium salt, and combinations thereof, wherein the formulation is free of sequestrants, exhibits enhanced antimicrobial efficacy over the formulations containing only component (i) or component (ii) as a biocide.

Component (i) of the disinfectant formulation according to the invention is selected from the group consisting of biguanides, monoguanides, and combinations thereof. The biguanide is disclosed in U.S. Application No. 2005/0014670. The publication is incorporated herein by reference in its entirety. Preferably the biguanide comprises at least two biguanide units of Formula (1):

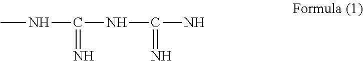

linked by a bridging group which contains at least one methylene group. The bridging group preferably includes a polymethylene chain, optionally containing one or more hetero atoms such as oxygen, sulphur or nitrogen. The bridging group may include one or more cyclic moieties which may be saturated or unsaturated. Preferably, the bridging group is such that there are at least three, and especially at least four, carbon atoms directly interposed between two adjacent biguanide units of Formula (1). Preferably, there are not greater than ten and especially not greater than eight carbon atoms interposed between two adjacent biguanide units of Formula (1).

The polymeric biguanide may be terminated by any suitable group, such as a hydrocarbyl, substituted hydrocarbyl or an amine group or a cyanoguanidine group of Formula (2):

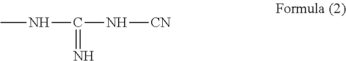

When the terminating group is hydrocarbyl, it is preferably alkyl, cycloalkyl, aryl or aralkyl. When the hydrocarbyl group is alkyl it may be linear or branched but is preferably linear. Preferred alkyl groups include C₁₋₈-alkyl. Examples of preferred alkyl groups include for example methyl, ethyl, n-propyl, isopropyl, n-pentyl, n-butyl, isobutyl, tert-butyl and n-octyl.

When the hydrocarbyl group is cycloalkyl, it is preferably cyclopropyl, cyclopentyl or cyclohexyl. When the hydrocarbyl group is aralkyl, it preferably contains from 1 to 6, more preferably 1 or 2 carbon atoms in the alkylene group attaching the aryl group to the biguanide. Preferred aralkyl groups include benzyl and 2-phenylethyl groups. Preferred aryl groups include phenyl groups.

When the terminating group is substituted hydrocarbyl, the substituent may be any substituent that does not exhibit undesirable adverse effects on the microbiological properties of the polymeric biguanide. Examples of such substituents are aryloxy, alkoxy, acyl, acyloxy, halogen and nitrile.

When the polymeric biguanide contains two biguanide groups of Formula (1), the biguanide is a bisbiguanide. The two biguanide groups are preferably linked through a polymethylene group, especially a hexamethylene group.

The polymeric biguanide preferably contains more than two biguanide units of Formula (1) and is preferably a linear polymeric biguanide which has a recurring polymeric chain represented by Formula (3) or a salt thereof:

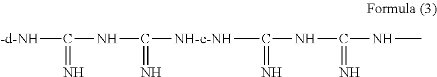

wherein d and e represent bridging groups which may be the same or different and in which together the total of the number of carbon atoms directly interposed between the pairs of nitrogen atoms linked by d plus the number of carbon atoms directly interposed between the pairs of nitrogen atoms linked by e is more than 9 and less than 17.

The bridging groups d and e preferably consist of polymethylene chains, optionally interrupted by hetero atoms, for example, oxygen, sulphur or nitrogen. D and e may also incorporate moieties which may be saturated or unsaturated, in which case the number of carbon atoms directly interposed between the pairs of nitrogen atoms linked by d and e is taken as including that segment of the cyclic group, or groups, which is the shortest. Thus, the number of carbon atoms directly interposed between the nitrogen atoms in the group

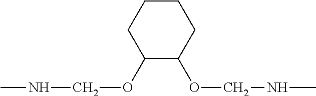

is 4 and not 8.

The linear polymeric biguanides having a recurring polymer unit of Formula (3) are typically obtained as mixtures of polymers in which the polymer chains are of different lengths. Preferably, the number of individual biguanide units of Formulae (4a) and (4b):

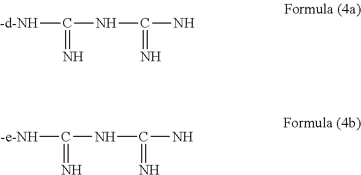

is, together, from 3 to about 80.

The preferred linear polymeric biguanide is a mixture of polymer chains in which d and e are identical and the individual polymer chains, excluding the terminating groups, are of the Formula (5) or a salt thereof:

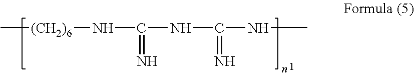

wherein n¹ is from 4 to 20 and especially from 4 to 18. It is especially preferred that the average value of n¹ is about 12. Preferably, the average molecular weight of the polymer in the free base form is from 1100 to 4000.

Preferably the polymeric biguanide is in the form of a salt. Preferred salts are those with organic or inorganic acids, especially water-soluble salts, for example, the chloride, gluconate, acetate or phosphate salt.

The linear polymeric biguanides may be prepared by the methods disclosed in U.S. Patent Application Publication 2005/0014670.

The PMG preferably comprises a plurality of groups of Formula (6) and/or groups of Formula (7) or salts thereof:

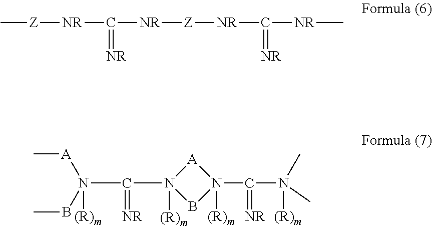

wherein: each m independently is 0 or 1; each Z independently is a C₂₋₁₈-hydrocarbyl group; A and B are hydrocarbyl groups which together comprise a total of 3 to 18 carbon atoms; each R independently is hydrogen, optionally substituted alkyl or optionally substituted alkoxy. Preferably each m is 0.

The hydrocarbyl groups in the PMG and represented by Z, A and B are optionally interrupted by one or more hetero atoms or groups and optionally carry one or more substituents other than hydrogen. Preferred interrupting atoms and groups are —O—, —NH—, —C(═O)— and phenylene. Preferred optional substituents are hydroxy; C₁₋₄-alkoxy; halo, especially chloro or bromo; nitro; amino; substituted amino; and acid groups, especially carboxy, sulpho and phosphato.

Preferably the hydrocarbyl groups in the PMG and represented by Z are C₂₋₁₈-alkylene (more preferably C₄₋₁₆-alkylene, especially C₆₋₁₂-alkylene, more especially C₆-alkylene); C₃₋₁₂-arylene, more preferably C₆₋₁₀-arylene, especially phenylene or naphthylene; C₇₋₁₂-arakylene (more preferably C₇₋₁₁-arylene, especially benzylene or xylyene); or a combination thereof, optionally interrupted by one or more —O—, —S—, —NH—or —C(═O)— groups.

Preferably the hydrocarbyl groups represented by A and B are each independently C₂₋₆-alkylene, optionally interrupted by one or more —O—, —S—, —NH— or —C(═O)— groups, with the proviso that A and B comprise a total of 3 to 12 carbon atoms, preferably 3 to 6 carbon atoms, more preferably 3 or 4 carbon atoms. In an especially preferred embodiment one of A or B is —CH₂— or —(CH₂)₂— and the other is —(CH₂)₂—, more especially both A and B are —(CH₂)₂—.

Examples of preferred -hydrocarbyl groups represented by Z include —CH₂C₆H₄CH₂—, CH₂OC₈H₄OCH₂—, —CH₂OC₆H₁₀OCH₂—, —(CH₂)₃O (CH₂)₃— and —(CH₂)₂S(CH₂)₂—.

Examples of particularly preferred -hydrocarbyl groups represented by Z include —(CH₂)₆, —(CH₂)₈—, —(CH₂)₁₂—, —CH₂CH(—CH₃)(CH₂)₄CH₃, 1,4-, 2,3- and 1,3-butylene, 2,5-hexylene, 2,7-heptylene and 3-methyl-1,6-hexylene,

It is preferred that all groups represented by Z are the same and are C₄₋₁₆-alkylene, more preferably C₄₋₁₂-alkylene, especially C₄₋₈-alkylene, more especially 1,6 hexylene.

Preferably each R independently is H, C₁₋₄-alkyl, C₁₋₄-alkoxy or C₁₋₄-alkoxy-OH, more preferably H or methyl, especially H.

Preferably the PMG consists essentially of groups of Formula (6).

Preferably all groups represented by R are the same. More preferably all groups represented by R are H.

The nature of the terminating groups on the PMG is not believed to be critical. Preferred terminating groups on the PMG are amino and guanidino.

In view of the foregoing preferences the PMG preferably comprises one or more groups of Formula (8) or salts thereof

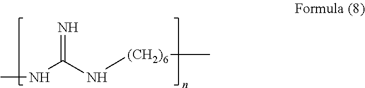

wherein: n is 2 to 50, preferably 3 to 25.

Preferably the PMG is in the form of a salt. Preferred salts are those with organic or inorganic acids, especially water-soluble salts, for example the chloride, gluconate, acetate or phosphate salt.

The PMGs may be prepared by the reaction of guanidine hydrochloride with a diamine, for example of the formula H₂N—Y—NH₂, HN(—A—) (—B—)NH or with a mixture of such diamines, wherein Z, A and B are as defined above.

It is to be understood that the PMG may also contain small amounts of repeating units other than repeat units of Formula (6) and (7). However it is preferred that the PMG consist essentially of or consists of repeat units of Formula (6) and/or (7) and terminating groups.

Examples include polyhexamethylene monoguanide such as SKAN B™ available from SK Corp, Korea and poly(oxyethylene)guanide hydrochloride such as Akacid™ available from POC, Austria.

A suitable example of a non-polymeric monoguanide includes n-docylguanide hydrochloride.

In a preferred embodiment, component (i) is polyhexamethylenebiguanide or the salts thereof. In another embodiment, component (i) is polyhexamethylenebiguanide hydrochloride salt.

Component (ii) of the disinfectant formulation of the invention is a compound selected from the group consisting of a dialkyldimethyl ammonium salt, an alkyldimethylbenzyl ammonium salt, an alkyldimethyl(ethylbenzyl) ammonium salt, and combinations thereof.

Regarding the dialkyldimethyl ammonium salt, the alkyl group can be a straight chain, a branched chain and/or a cyclic chain group. They can be the same or different. Preferably, the alkyl groups are C₈-C₂₀ alkyl, more preferably C₈-C₁₂ alkyl. The exemplary salts are halide, acetate, nitrite, a lower alkosulfate, carbonate, bicarbonate, and/or an alkyl carboxylate. The preferred dialkyldimethyl ammonium salt is didecyldimethyl ammonium chloride, didecyldimethyl ammonium carbonate, didecyldimethyl ammonium bicarbonate, or combinations thereof.

The alkyldimethylbenzyl ammonium salt and the alkyldimethyl(ethylbenzyl) ammonium salt are not particularly limited. Preferably, the alkyl group is a C₈-C₂₀ alkyl, more preferably C₈-C₁₂ alkyl. The salts can be halide, acetate, nitrite, a lower alkosulfate, carbonate, bicarbonate, and/or an alkyl carboxylate. In one embodiment, it is a chloride salt. In another embodiment, it is a carbonate salt, a bicarbonate salt or combinations thereof.

In addition to components (i) and (ii), the disinfectant formulations of the invention may additionally contain a non ionic surfactant. Suitable non ionic surfactant includes but are not limited to alkoxylated alcohols.

Examples of alkoxylated alcohols suitable for use for the disinfectant formulations of the invention include the condensation products of aliphatic (C₈-C₂₀, preferably C₈-C₁₆) primary or secondary linear or branched chain alcohols or phenols with alkylene oxides, preferably ethylene oxide or propylene oxide, most preferably ethylene oxide, and generally having from 15 to 80, preferably 16 to 80, more preferably up to 20 or from 20 to 80, and most preferably 20 to 50 alkylene oxide groups. For the sake of clarity, the alkylene oxide group is the hydrophilic repeating unit.

According to an especially preferred embodiment of the invention, the nonionic surfactant (ii) is an ethoxylated aliphatic alcohol of the formula (9): R—(—O—CH₂-CH₂)ₙ—OH wherein R is a hydrocarbyl chain having from 8 to 16 carbon atoms, and the average degree of ethoxylation n is from 15 to 50, preferably 20 to 50.

The hydrocarbyl chain, which is preferably saturated, preferably contains from 10 to 16 carbon atoms, more preferably from 12 to 15 carbon atoms. In commercial materials containing a spread of chain lengths, these figures represent an average. The hydrocarbyl chain may be linear or branched.

The alcohol may be derived from natural or synthetic feedstock. Preferred alcohol feedstocks are coconut, predominantly C₁₂-C₁₄, and oxo C₁₂-C₁₅ alcohols.

The average degree of ethoxylation ranges from 15 to 50, preferably from 16 to 50, more preferably from 20 to 50, and most preferably from 25 to 40.

Preferred materials have an average alkyl chain length of C₁₂-C₁₆ and an average degree of ethoxylation of from 16 to 40, more preferably from 25 to 40.

In one embodiment, the alkoxylated alcohol is trimethylnonyl polyethylene glycol ether.

The total amount of component (i) and (ii) in the ready to use disinfectant formulation is from about 500 ppm to about 1000 ppm, advantageously from about 500 ppm to about 700 ppm. Component (i) and component (ii) are present in a weight ratio of from about 1:1 to 1:10, advantageously from about 1:1 to about 1:5, more advantageously from about 1:2 to about 1:5.

If present, the alkoxylated alcohol is suitably present in the disinfectant formulation in an amount of from about 100 ppm to about 500 ppm, preferably from about 150 ppm to about 250 ppm.

The disinfectant formulation of the present invention may also include some optional ingredients. Suitable ingredients include but not limited to acetic acid and its sodium salt, α-Alkyl (C₁₀-C₁₄)-ω-hydroxypoly (oxyethylene) poly(oxypropylene) average molecular weight (in amu), 768 to 837; α-Alkyl(C₁₂-C₁₈)-ω-hydroxypoly (oxyethylene) poly(oxypropylene) average molecular weight (in amu), 950 to 1120; Ethanol; tetrasodium salt; α-(p-Nonylphenyl)-ω-hydroxypoly (oxyethylene) average poly(oxyethylene) (content 11 moles); Octanoic acid; citric acid, the salts and esters thereof, fumaric acid, lactic acid, n-butyl ester, lactic acid, ethyl ester, 2-propanol, sorbic acid and potassium salt.

In one embodiment, the combination of antimicrobial components for the disinfectant formulation can be provided in the form of a disinfectant composition concentrate that, upon dilution with water, provides antimicrobial efficacy in a disinfectant formulation. The concentrate comprises: component (i) in an amount of between about 1% and about 11%, preferably between about 2% and about 6%, and component (ii) in an amount of between about 5% and about 21%, preferably between about 10% and about 15% based on the total weight of the disinfectant composition concentrate, wherein the component (i) and the component (ii) are present in weight ratio range of between about 1:1 and about 1:10, advantageously from about 1:1 to about 1:5, more advantageously from 1:2 to about 1:5, and wherein the concentrate is free of sequestrants.

If present, the alkoxylated alcohol is suitably present in the disinfectant composition concentrate in an amount of from about 2.5% to about 13%, preferably from about 3.5% to about 6.5% based on the total weight of the disinfectant composition concentrate.

Advantageously, the disinfectant formulations and the formulation concentrates of the present invention are free of sequestrants such as an acetic acid derivative selected from the group consisting of ethylenediaminetetraactic acid, nitrilotriacetic acid, tetrasodium EDTA.

The ready to use formulations or the formulation concentrates of the present invention can be prepared by any conventional means. The methods include mixing different components in any order.

The ready to use disinfectant formulation can be used for cleaning and disinfecting surfaces. The method includes the step of contacting the surfaces to be disinfected with a ready to use disinfectant formulation according to the present invention. If a formulation concentrate is provided, a user can dilute the concentrate to a ready to use formulation, then apply the formulation to the surface to be disinfected.

The invention is further described in the examples given below. All percentages given herein are weight percents based on the total weight of the composition, unless otherwise stated. All patents referred to in this application are incorporated herein by reference in their entirety.

### Example 1

Simple mixtures of PHMB with DDAC are known to be unstable. Several co-formulants were identified to allow the mixture to be delivered as a stable concentrate. The result is shown in Table 1.

TABLE 1
Stability of PHMB, DDAC Mixtures

| | PHMB | DDAC | Co-formulant | | |
|---|---|---|---|---|---|
| Formu- | (% | (% | Trade Name/ | Level | |
| lation | active) | active) | Chemical Name | (% a.i.) | Stable |
| 1 | 5 | 5 | | 0 | No |
| 2 | 5 | 5 | Makon 10 (nonylphenol | 3 | Yes |
| | | | ethoxylate POE-10) | | |
| 3 | 5 | 5 | Makon 12 (nonylphenol | 3 | Yes |
| | | | ethoxylate POE-12) | | |
| 4 | 5 | 5 | Neutronyx 656 (nonyl- | 3 | Yes |
| | | | phenol ethoxylate) | | |
| 5 | 5 | 5 | Tween 20 (Polyoxyeth- | 3 | Yes |
| | | | ylene (20) sorbitan | | |
| | | | monolaurate) | | |
| 6 | 5 | 5 | Tergitol TMN10 | 3 | Yes |
| | | | (trimethylnonyl poly- | | |
| | | | ethylene glycol ether) | | |

### Example 2

Sanitizer concentrates were prepared using PHMB, DDAC and a non ionic surfactant (Tergitol TMN 10) or PHMB, DDAC and ADBAC. The details of the concentrate compositions are listed in Table 2.

TABLE 2
Sanitizer Formulations

| | | | | | | Maximum |
|---|---|---|---|---|---|---|
| | PHMB | DDAC | | Tergitol | | Use Limit |
| Formu- | (% | (% | ADBAC | TMN 10 | Use | (ppm |
| lation | active) | active) | (% active) | (% active) | Dilution | active) |
| 7 | 0 | 3.84 | 0 | 3 | 256 | 240 |
| 8 | 0.64 | 3.2 | 0 | 3 | 256 | 288 |
| 9 | 0.77 | 3.07 | 0 | 3 | 256 | 300 |
| 10 | 0.96 | 2.88 | 0 | 3 | 256 | 320 |
| 11 | 1.28 | 2.56 | 0 | 3 | 256 | 360 |
| 12 | 1.92 | 1.92 | 0 | 3 | 256 | 480 |
| 13 | 2.56 | 1.28 | 0 | 3 | 256 | 720 |
| 14 | 2.74 | 1.10 | 0 | 3 | 256 | 780 |
| 15 | 3.84 | 0 | 0 | 3 | 256 | 540 |
| 16 | 0 | 1.92 | 1.92 | 0 | 256 | 200 |
| 17 | 0.64 | 1.60 | 1.60 | 0 | 256 | 240 |
| 18 | 0.77 | 1.54 | 1.54 | 0 | 256 | 250 |
| 19 | 0.96 | 1.44 | 1.44 | 0 | 256 | 267 |
| 20 | 1.28 | 1.28 | 1.28 | 0 | 256 | 300 |
| 21 | 1.92 | 0.96 | 0.96 | 0 | 256 | 400 |
| 22 | 2.56 | 0.64 | 0.64 | 0 | 256 | 600 |
| 23 | 2.74 | 0.55 | 0.55 | 0 | 256 | 698 |
| 24 | 3.84 | 0 | 0 | 0 | 256 | 540 |
| 25 | 1.92 | 3.84 | 0 | 3 | 384 | 360 |
| 26 | 2.88 | 2.88 | 0 | 3 | 384 | 480 |
| 27 | 2.56 | 5.12 | 0 | 3 | 512 | 360 |
| 28 | 3.84 | 3.84 | 0 | 3 | 512 | 480 |
| 29 | 1.92 | 1.92 | 1.92 | 0 | 384 | 300 |
| 30 | 2.56 | 2.56 | 2.56 | 0 | 512 | 300 |

### Example 3

Certain formulations as listed in Tables 1 and 2 were tested for biocidal activity. The results are shown in Tables 3 and 4.

The Association of Official Analytical Chemists (AOAC) Germicidal and Detergent Sanitizers Method is a method required to generate data to support the efficacy data requirements for sanitizing rinses (for previously cleaned food-contact surfaces). When claims for the effectiveness of the product in hard water are made, all required data must be developed at the hard water tolerance claimed. Acceptable results must demonstrate a 99.999% reduction in the number of microorganisms within 30 seconds against both Escherichia coli ATCC and Staphylococcus aureus ATCC 6538.

As shown from the tables, mixtures of DDAC, PHMB with surfactant Tergitol and mixtures of DDAC and ADBAC with PHMB have improved biocidal activity over the individual components. Certain levels of the active ingredients were shown to pass AOAC Germicidal and Detergent Sanitizer (G&DS) test to a level of 500 ppm synthetic water hardness.

TABLE 3
Relative Performance and Cost of Various Ratios of PHMB:DDAC
(Co-formulated with Tergitol TMN 10)

| | | | Performance in | | | Cost |
|---|---|---|---|---|---|---|
| | | | AOAC G&DS at | | | In Use |
| Formulation | ppm active | | 150 ppm active | | Pass/ | ($/litre |
| Number | PHMB | DDAC | E. coli | S. aureus | Fail | of RTU) |
| 7 | 0 | 150 | 99.998 | 100.000 | F | 0.005 |
| 8 | 25 | 125 | 100.000 | 100.000 | P | 0.006 |
| 9 | 30 | 120 | 100.000 | 100.000 | P | 0.007 |
| 10 | 37.5 | 112.5 | 100.000 | 100.000 | P | 0.007 |
| 11 | 50 | 100 | 100.000 | 100.000 | P | 0.007 |
| 12 | 75 | 75 | 100.000 | 100.000 | P | 0.008 |
| 13 | 100 | 50 | 100.000 | 100.000 | P | 0.009 |
| 14 | 107 | 43 | 100.000 | 100.000 | P | 0.010 |
| 15 | 150 | 0 | 99.992 | 99.983 | F | 0.011 |

RTU = Ready to Use Sanitizer Formulation

TABLE 4
Relative Performance and Cost of Various Ratios of PHMB:ADBAC:DDAC

| | | | | Performance in | | | |
|---|---|---|---|---|---|---|---|
| | | | | AOAC G&DS at | | | |
| Formulation | ppm active | | | 150 ppm active | | Pass/ | Cost In Use |
| Number | PHMB | DDAC | ADBAC | E. coli | S. aureus | Fail | ($/litre of RTU) |
| 16 | 0 | 75 | 75 | 99.992 | 100.000 | F | 0.005 |
| 17 | 25 | 62.5 | 62.5 | 99.996 | 100.000 | F | 0.006 |
| 18 | 30 | 60 | 60 | 99.994 | 100.000 | F | 0.006 |
| 19 | 37.5 | 56.3 | 56.3 | 99.999 | 100.000 | P | 0.007 |
| 20 | 50 | 50 | 50 | 100.000 | 100.000 | P | 0.007 |
| 21 | 75 | 37.5 | 37.5 | 99.997 | 100.000 | F | 0.008 |
| 22 | 100 | 25 | 25 | 99.998 | 99.974 | F | 0.009 |
| 23 | 107 | 21.5 | 21.5 | 100.000 | 99.974 | F | 0.009 |
| 24 | 150 | 0 | 0 | 99.900 | 99.540 | F | 0.011 |

RTU = Ready to Use sanitizer formulation

### Example 4

VANTOCIL™ NR3.8 (PHMB:ADBA:DDACC at 1:1:1 ratio) and Bardac™ 205M ( a mixture of alkyl dimethyl benzyl ammonium chloride (ADBAC), didecyl dimethyl ammonium chloride (DDAC), octyl decyl dimethyl ammonium chloride and dioctyl dimethyl ammonium chloride) were tested for their tolerance to the negative effects of hard water using the AOAC G&DS Test described above in Example 3.

The hard water level, which is represented by the ppm value of CaCO₃ in water, and the pass level, which is the amount of the actives required to reduce the bacterial numbers in 30 seconds, are shown in Table 5.

TABLE 5
Tolerance to the negative effects of hard water

| | Hard Water Level | |
|---|---|---|
| Product | (ppm CaCO₃) | Pass Level (ppm active) |
| VANTOCIL NR3.8 | 500 | 150 |
| (PHMB + ADBAC + | 700 | 400 |
| DDAC @ 1:1:1 ratio) | | |
| Bardac 205M | 500 | 250 |
| | 700 | 500 |

As shown from the table, the mixture of PHMB, ADBAC and DDAC is more tolerant to the negative effects of hard water compared to the mixture that contains quaternary ammonium compounds but not PHMB.

### Example 5

In the US, the efficacy requirements for disinfectants for use on hard surfaces are defined by EPA DIS/TSS-1 Jan. 22, 1982. For hard surface disinfectants to be used in a hospital or medical environment then efficacy claims must demonstrate additional effectiveness against the nosocomial bacterial pathogen Pseudomonas aeruginosa. The test method employed should be the AOAC Use-Dilution Method, utilizing sixty carriers and achieving the performance requirement of killing 59 out of each set of 60 carriers. The EPA Standard Operating Procedure for AOAC Use Dilution Method for Testing Disinfectants (SOP Number: MB-05-08, Date Revised: 02-04-10) defines that the mean log density for carriers inoculated with Pseudomonas aeruginosa must be at least 6.0 (corresponding to a geometric mean density of 1.0×10⁶); a mean log density below 6.0 invalidates the test. At these defined carrier count levels, individually both quaternary ammonium compounds and poly(hexamethylene) biguanide or it's salts (PHMB) show low activity against Ps. aeruginosa. This example illustrates several alternatives comprising of mixtures of quaternary ammonium compounds and poly(hexamethylene) biguanide hydrochloride.

Formulations 31-42 as shown in Table 6 were prepared by mixing PHMB, quaternary compounds, and alcohol ethoxylate. These formulations were tested for effectiveness against Ps. aeruginosa ATCC 15442 using AOAC Use-Dilution Method (SOP Number: MB-05-08, Date Revised: 02-04-10). The results are reported in Table 6.

As a comparison, formulations containing only quaternary ammonium compounds or PHMB as actives were prepared and tested against Ps. aeruginosa ATCC 15442 using AOAC Use-Dilution Method. The results are reported in Tables 7 and 8.

The results show that formulations containing solely quaternary ammonium compounds and formulations containing solely PHMB showed low antimicrobial activity against Ps. aeruginosa. In contrast, formulations containing both PHMB and quaternary ammonium compounds showed enhanced efficacy over the quaternary ammonium compounds based formulations and PHMB based formulations.

TABLE 6
QAC/PHMB Based Formulation Efficacy

| | | | | Active Ingredient | | | | | Number of | Pass/Fail |
|---|---|---|---|---|---|---|---|---|---|---|
| | | | | Levels | | | | | Positive | (Pass = ≦1 positive |
| | Formulation Details | | | (Use Dilution) | | | Mean | Number of Positive | Subculture | subculture tube |
| | (Concentrate) (% active) | | | ppm a.i. | | | Log | Subculture | Tubes (2° | Fail = >1 positive |
| Formulation | PHMB | QAC | Surfactant | PHMB | QAC | Surfactant | Density | Tubes (1° tubes) | tubes) | subculture) |
| 31 | 2.56 | ADBAC -12.8 | Synperonic | 100 | 500 | 200 | 6.2 | 0 | 0 | Pass |
| | | | 91/6-5 | | | | | | | |
| 32 | 5.12 | ADBAC- | Synperonic | 200 | 400 | 200 | 6.3 | 1 | 1 | Pass |
| | | 10.24 | 91/6-5 | | | | | | | |
| 33 | 2.56 | DDAC - 12.8 | Synperonic | 100 | 500 | 200 | 6.1 | 1 | 0 | Pass |
| | | | 91/6-5 | | | | | | | |
| 34 | 5.12 | DDAC - | Synperonic | 200 | 400 | 200 | 6.6 | 0 | 0 | Pass |
| | | 10.24 | 91/6-5 | | | | | | | |
| 35 | 3.84 | ADBAC - | Synperonic | 150 | 450 | 150 | 6.1 | 0 | 0 | Pass |
| | | 11.52 | 91/6-4 | | | | | | | |
| 36 | 3.84 | ADBAC - | Synperonic | 150 | 450 | 200 | 6.1 | 0 | 0 | Pass |
| | | 11.52 | 91/6-4 | | | | | | | |
| 37 | 3.07 | ADBAC - | Synperonic | 120 | 480 | 150 | 6.5 | 0 | 0 | Pass |
| | | 12.29 | 91/6-4 | | | | | | | |
| 38 | 3.07 | ADBAC - | Synperonic | 120 | 480 | 200 | 5.1 | 0 | 1 | Pass |
| | | 12.29 | 91/6-5 | | | | | | | |
| 39 | 3.84 | DDAC - | Synperonic | 150 | 450 | 200 | 4.2 | 0 | 0 | Pass |
| | | 11.52 | 91/6-5 | | | | | | | |
| 40 | 3.07 | DDAC - | Synperonic | 120 | 480 | 200 | 4.4 | 0 | 1 | Pass |
| | | 12.29 | 91/6-5 | | | | | | | |

TABLE 7
QAC Based Formulation Efficacy

| | | | | | | Number of | Number of | Pass/Fail |
|---|---|---|---|---|---|---|---|---|
| | | | | | | Positive | Positive | (Pass = ≦1 positive |
| Formulation Details | | | | Concentration | | Subculture | Subculture | subculture tube) |
| (Concentrate) (% active) | | | | Tested (ppm | Mean log | Tubes (1° | Tubes (2° | Fail = >1 positive |
| DDAC | ADBAC | Na₄EDTA | Surfactant | active biocide) | density | tubes) | tubes) | subculture tube) |
| 10.14 | 6.76 | 3.12 | Synperonic | 800 | 6.8 | 8 | 6 | Fail |
| | | | 91/6-2.4 | | | | | |
| 10.14 | 6.76 | 3.12 | Synperonic | 1000 | 6.8 | 6 | 4 | Fail |
| | | | 91/6-2.4 | | | | | |
| 10.14 | 6.76 | 3.12 | Synperonic | 1200 | 6.8 | 4 | 4 | Fail |
| | | | 91/6-2.4 | | | | | |

Formulation: DDAC + ADBAC + non ionic surfactant (alcohol ethoxylate) + Na₄EDTA, neutral pH

TABLE 8
PHMB Based Formulation Efficacy

| | | | | | Pass/Fail |
|---|---|---|---|---|---|
| | | | | | (Pass = ≦1 |
| | | | Number of | Number of | positive |
| | Concentra- | Mean | Positive | Positive | subculture tube) |
| | tion Tested | log | Subculture | Subculture | Fail = >1 |
| Bio- | (ppm active | den- | Tubes | Tubes | positive |
| cide | biocide) | sity | (1° tubes) | (2° tubes) | subculture tube) |
| PHMB | 900 | 6.3 | 1 | 3 | Fail |
| PHMB | 1200 | 6.3 | 1 | 2 | Fail |
| PHMB | 1500 | 6.3 | 0 | 1 | Pass |

Formulation: Aqueous solution of PHMB

What is claimed is:

1. A disinfectant formulation comprising: (i) an antimicrobial active agent selected from the group consisting of biguanides, monoguanides, and combinations thereof; (ii) a compound selected from the group consisting of a dialkyldimethyl ammonium salt, an alkyldimethylbenzyl ammonium salt, an alkyldimethyl(ethylbenzyl) ammonium salt, and combinations thereof, wherein the total amount of the component (i) and the component (ii) is from about 500 ppm to about 1000 ppm based on the weight of the disinfectant formulation, wherein the component (i) and the component (ii) are present in a range of weight ratios between about 1:1 and about 1:10, and wherein the formulation is free of sequestrants.

2. The disinfectant formulation of claim 1 wherein the component (i) is polyhexamethylene biguanide or the salts thereof.

3. The disinfectant formulation of claim 1 wherein the component (ii) is selected from the group consisting of dialkyldimethyl ammonium chloride, dialkyldimethyl ammonium bicarbonate, dialkyldimethyl ammonium carbonate, alkyldimethylbenzyl ammonium chloride, alkyldimethylbenzyl ammonium carbonate, alkyldimethylbenzyl ammonium dicarbonate, alkyldimethyl(ethylbenzyl) ammonium chloride, alkyldimethyl(ethylbenzyl) ammonium bicarbonate alkyldimethyl(ethylbenzyl) ammonium carbonate, and combinations thereof,

4. The disinfectant formulation of claim 3 wherein the component (ii) is selected from the group consisting of didecyldimethyl ammonium chloride, didecyldimethyl ammonium bicarbonate, didecyldimethyl ammonium carbonate, alkyldimethylbenzyl ammonium chloride, alkyldimethylbenzyl ammonium carbonate, alkyldimethylbenzyl ammonium dicarbonate, alkyldimethyl(ethylbenzyl) ammonium chloride, alkyldimethyl(ethylbenzyl) ammonium bicarbonate alkyldimethyl(ethylbenzyl) ammonium carbonate, and combinations thereof,

5. The disinfectant formulation of claim 1 wherein the formulation further comprises a non ionic surfactant.

6. The disinfectant formulation of claim 5 wherein the non ionic surfactant is a alkoxylated alcohol.

7. The disinfectant formulation of claim 6 wherein the alkoxylated alcohol is present in an amount of from about 100 ppm to about 500 ppm.

8. A disinfectant composition concentrate, which upon dilution with water provides the amounts of components (i) and (ii) as specified in claim 1, the concentrate comprising the component (i) in an amount of between about 1% and about 12%, the component (ii) in an amount of between about 5% and about 22%, based on the total weight of the disinfectant composition concentrate, and wherein the component (i) and the component (ii) are present in weight ratio range of between about 1:1 and about 1:10.

9. The disinfectant composition concentrate of claim 8 wherein the component (i) is polyhexamethylenebiguanide or the salts thereof.

10. The disinfectant composition concentrate of claim 8 wherein the component (ii) is selected from the group consisting of dialkyldimethyl ammonium chloride, dialkyldimethyl ammonium bicarbonate, dialkyldimethyl ammonium carbonate, alkyldimethylbenzyl ammonium chloride, alkyldimethylbenzyl ammonium carbonate, alkyldimethylbenzyl ammonium dicarbonate, alkyldimethyl(ethylbenzyl) ammonium chloride, alkyldimethyl(ethylbenzyl) ammonium bicarbonate alkyldimethyl(ethylbenzyl) ammonium carbonate, and combinations thereof,

11. The disinfectant formulation of claim 10 wherein the component (ii) is selected from the group consisting of didecyldimethyl ammonium chloride, didecyldimethyl ammonium bicarbonate, didecyldimethyl ammonium carbonate, alkyldimethylbenzyl ammonium chloride, alkyldimethylbenzyl ammonium carbonate, alkyldimethylbenzyl ammonium dicarbonate, alkyldimethyl(ethylbenzyl) ammonium chloride, alkyldimethyl(ethylbenzyl) ammonium bicarbonate alkyldimethyl(ethylbenzyl) ammonium carbonate, and combinations thereof,

12. The disinfectant composition concentrate of claim 8 further comprising a alkoxylated alcohol.

13. The disinfectant composition concentrate of claim 8 wherein the composition is free of sequestrants.

14. A method for disinfecting a surface comprising contacting the disinfectant formulation of claim 1 with the surface to be disinfected.

15. A method for disinfecting a surface comprising the steps of: providing a disinfectant formulation concentrate according to claim 8, diluting the disinfectant formulation concentrate to provide a ready to use antimicrobially effective disinfectant formulation according to claim 1, and contacting the ready to use disinfectant formulation with the surface to be disinfected.
